(19) United States
(12) Patent Application Publication
(10) Pub. No.: US 2018/0184069 A1
(43) Pub. Date: Jun. 28, 2018

(54) STRUCTURED-LIGHT-BASED EXPOSURE CONTROL METHOD AND EXPOSURE CONTROL APPARATUS

(71) Applicants: LITE-ON ELECTRONICS (GUANGZHOU) LIMITED, GUANGZHOU (CN); Lite-On Technology Corporation, Taipei (TW)

(72) Inventors: Hsing-Hung Chen, Taipei (TW); Chan-Min Chou, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 15/458,979

(22) Filed: Mar. 15, 2017

(30) Foreign Application Priority Data
Dec. 23, 2016 (CN) 201611209441.8

(51) Int. Cl. H04N 13/02; H04N 5/235; H04N 13/00

(52) U.S. Cl. CPC H04N 13/0253; H04N 13/004; H04N 5/2356

(57) ABSTRACT

A structured-light-based exposure control method and an exposure control apparatus are provided. The exposure control method includes projecting a plurality of structured lights with a plurality of scanning patterns by a projector with a first projector brightness on an object to scan the object, capturing a plurality of first images of the object corresponding to the scanning patterns, calculating a first stereo image according to the first images, projecting the structured lights with the scanning patterns by the projector with a second projector brightness on the object to scan the object, capturing a plurality of second images of the object corresponding to the scanning patterns, wherein the second projector brightness is less than the first projector brightness, calculating a second stereo image according to the second images, and stitching the first stereo image and the second stereo image to obtain a first complete stereo image.

### CROSS-REFERENCE TO RELATED APPLICATION

This application claims the priority benefit of China application serial no. 201611209441.8, filed on Dec. 23, 2016. The entirety of the above-mentioned patent application is hereby incorporated by reference herein and made a part of this specification.

### FIELD OF THE INVENTION

The invention relates to an exposure control method and an exposure control apparatus. More specifically, the invention relates to a structured-light-based exposure control method and a structured-light-based exposure control apparatus.

### DESCRIPTION OF RELATED ART

In the field of the computer graphics, three-dimensional image acquisition and data analysis are required for geometrically measuring the appearance and contour of an object, and said geometric measurement technology has been applied in the fields of industrial design, reverse engineering, inspection of parts, digital archiving of cultural artifacts, and cultural relics and archaeology research.

The existing time-coded structured lights are able to provide considerably delicate scanning results. In the scanning method, the structured lights with different phase shifts and frequencies are projected onto a surface of an object, and an image capturing apparatus captures a plurality of images of the deformed structured lights affected by a contour of the surface of the object, so as to obtain a complete surface information of the object through analyzing the images. Nevertheless, when the structured lights with the patterns are projected onto the surface of the object, overexposure may lead to erroneous stereo information; alternatively, low confidence caused by underexposure may cause the high error rate of calculating the stereo information.

### SUMMARY OF THE INVENTION

The invention provides a structured-light-based exposure control method and a structured-light-based exposure control apparatus for obtaining a complete stereo image by stitching stereo images with different exposure conditions.

In an embodiment of the invention, a structured-light-based exposure control method is suitable for an exposure control apparatus equipped with a projector and an image capturing apparatus. The exposure control method includes following steps. Structured lights with a plurality of scanning patterns are projected on an object by the projector with a first projector brightness to scan the object. Plural first images of the object corresponding to the scanning patterns are captured by the image capturing apparatus. A first stereo image is calculated according to the first images. Structured lights with the scanning patterns are projected on the object by the projector with a second projector brightness to scan the object. Plural second images of the object corresponding to the scanning patterns are captured by the image capturing apparatus. A second stereo image is calculated according to a plurality of second images. The first stereo image and the second stereo image are stitched to obtain a first complete stereo mage. Here, the second projector brightness is less than the first projector brightness.

In an embodiment of the invention, a structured-light-based exposure control apparatus includes a projector, an image capturing apparatus, and a processor. The processor is coupled to the projector and the image capturing apparatus. The processor instructs the projector with a first projector brightness to project a plurality of structured lights with a plurality of scanning patterns on an object to scan the object and instructs the image capturing apparatus to capture a plurality of first images of the object corresponding to the scanning patterns. A first stereo image is calculated by the processor according to the first images. The processor instructs the projector with a second projector brightness to project the structured lights with the scanning patterns on the object to scan the object and instructs the image capturing apparatus to capture a plurality of second images of the object corresponding to the scanning patterns. The second projector brightness is less than the first projector brightness. The processor calculates a second stereo image according to the second images and stitches the first stereo image and the second stereo image to obtain a first complete stereo image.

In view of the foregoing, in the exposure control method and the exposure control apparatus provided by the invention, the structured lights with the scanning patterns are projected on the object by the projector with different projector brightnesses to scan the object, and the first images and the second images corresponding to the different projector brightnesses are captured. The first stereo image and the second stereo image are then stitched to obtain the complete stereo image.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block view illustrating an exposure control apparatus according to an embodiment of the invention.

FIG. 2 is a schematic view illustrating an exposure control apparatus according to an embodiment of the invention.

FIG. 3 is a flow chart illustrating an exposure control method according to an embodiment of the invention.

FIG. 4 is a schematic view illustrating an overexposed stereo image according to an embodiment of the invention.

FIG. 5 is a schematic view illustrating an underexposed stereo image according to an embodiment of the invention.

FIG. 6 is a schematic view illustrating a combination of an overexposed stereo image and an underexposed stereo image according to an embodiment of the invention.

### DESCRIPTION OF THE EMBODIMENTS

Several embodiments of the invention are described in detail below accompanying with figures. In terms of the reference numerals used in the following descriptions, the same reference numerals in different figures should be considered as the same or the like elements. The embodiments are only a portion of the invention, which do not present all embodiments of the invention. More specifically, the embodiments as examples of the method and the apparatus fall within the scope of the claims of the invention.

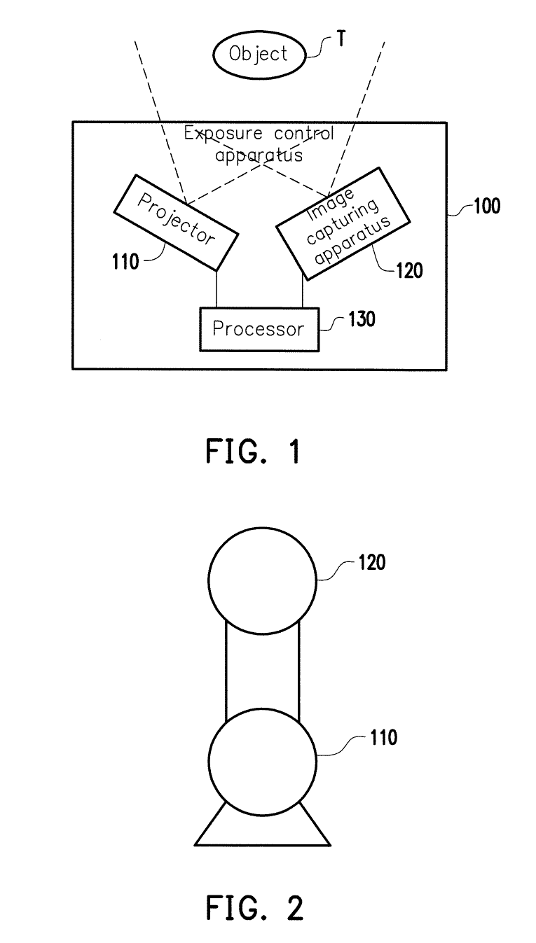

FIG. 1 is a block view illustrating an exposure control apparatus according to an embodiment of the invention. FIG. 2 is a schematic view illustrating an exposure control apparatus according to an embodiment of the invention. The illustrations are provided to make the description more comprehensible, and it should be noted that the invention is not limited thereto.

Referring to FIG. 1 and FIG. 2, an exposure control apparatus 100 includes a projector 110, an image capturing apparatus 120, and a processor 130. The processor 130 is coupled to the projector 110 and the image capturing apparatus 120. The exposure control apparatus 100 may be configured to scan an object T to obtain stereo information of the object T. In the embodiment, the image capturing apparatus 120 may be disposed above the projector 110, as shown in FIG. 2. Nevertheless, the invention is not limited to what is shown in FIG. 2. For instance, the projector 110 and the image capturing apparatus 120 may also be disposed horizontally or in other manner.

In the embodiment, the image capturing apparatus 120 is configured to capture an image of the object T. The image capturing apparatus 120 includes a camera lens and a photosensitive device. The camera lens is constituted by a lens, and the photosensitive device is configured to respectively sense the intensity of lights entering into the lens and thereby respectively generate images. The photosensitive device may be, for example, a charge coupled device (CCD), a complementary metal-oxide semiconductor (CMOS), or any other device, but the invention is not limited thereto.

In the embodiment, the processor 130 is coupled to the projector 110 and the image capturing apparatus 120. The processor 130 may be, for example, a central processing unit (CPU), a programmable microprocessor for general or special use, a digital signal processor (DSP), a programmable controller, an application specific integrated circuit (ASIC), a programmable logic device (PLD), another similar device, or a combination of the foregoing devices.

People having ordinary skill in the art should understand that the exposure controller apparatus 100 further includes a data storage apparatus (not shown in the drawings) that may be coupled to the projector 110, the image capturing apparatus 120, and the processor 130 for storing images and data. The data storage apparatus, for example, may be a fixed or a movable random access memory (RAM) in any form, a read-only memory (ROM), a flash memory, a hard disc, another similar device, or a combination of the foregoing devices.

In the embodiment, the processor 130 may instruct the projector 110 to perform a structured-light-scanning operation on the object T; that is, the projector 110 is instructed to sequentially project the structured lights with a plurality of scanning patterns on the object T to scan the object T. For instance, the projector 110 may sequentially project structured lights with scanning patterns 1 to 6 on the object T. The scanning patterns 1 to 3 may have a first spatial frequency, and the scanning patterns 4 to 6 may have a second spatial frequency different from the first spatial frequency. The scanning patterns 1 to 3 and the scanning patterns 4 to 6 may be sine wave-shaped patterns or cosine wave-shaped patterns, and each pattern may include three different phase shifts (e.g., −120 degrees, 0 degree, and 120 degrees). When the structured lights with the scanning patterns 1 to 6 are projected on the object T, the processor 130 instructs the image capturing apparatus 120 to capture a plurality images of the object T. Hence, the three different phase shifts of the scanning patterns 1 to 3 and the scanning patterns 4 to 6 may respectively correspond to one of the images captured by the image capturing apparatus 120. More specifically, when the structured light with the scanning pattern 1 is projected on the object T, the image capturing apparatus 120 captures the image of the object T corresponding to the scanning pattern 1. Similar examples may apply when structured lights with other scanning patterns are projected on the object T. It should be noted that, although in the embodiment, two sets of the structured lights with the scanning patterns of different spatial frequencies are adopted to scan the object T, the invention is not limited thereto. In another embodiment, three or more sets of the structured lights with the scanning patterns of different spatial frequencies may also be adopted to scan the object T to achieve an accurate scanning result. In addition, in the embodiment, although the scanning patterns at the same spatial frequency have three different phase shifts, the invention is not limited thereto. In another embodiment, the scanning patterns at the same spatial frequency may have four or more different phase shifts.

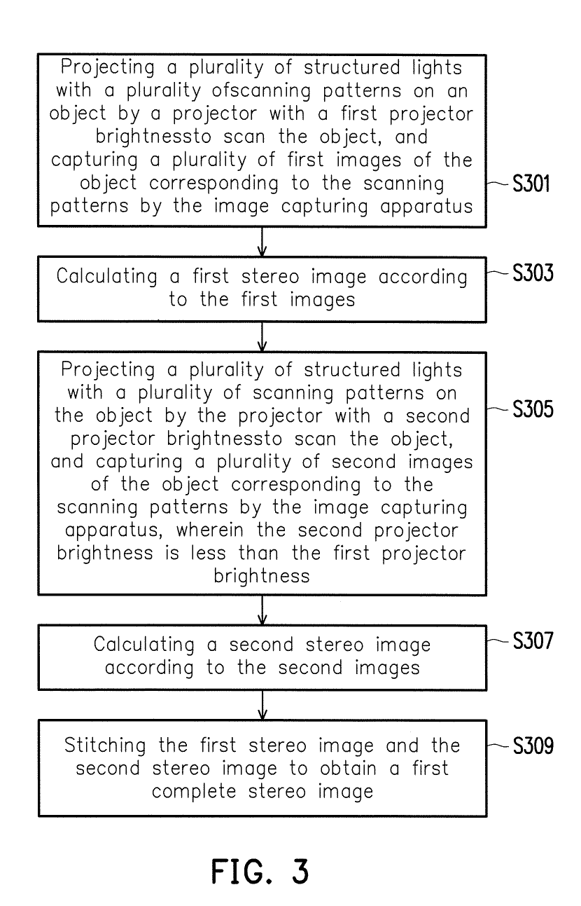

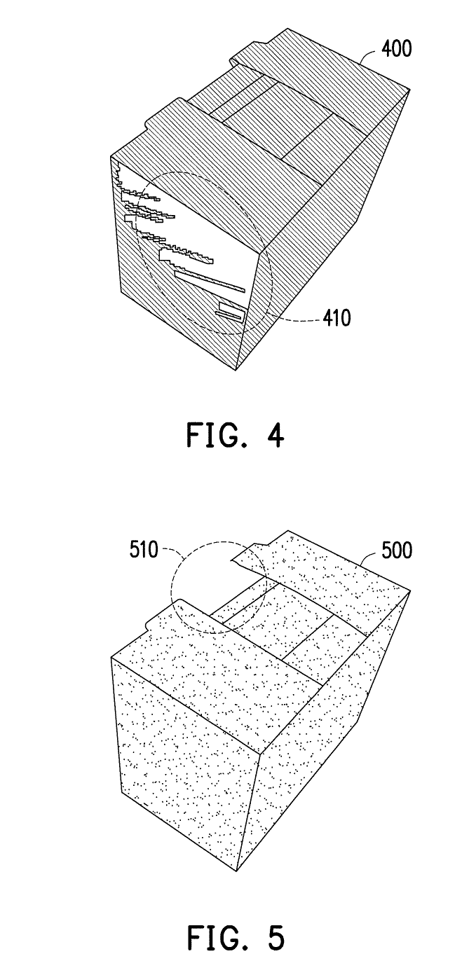

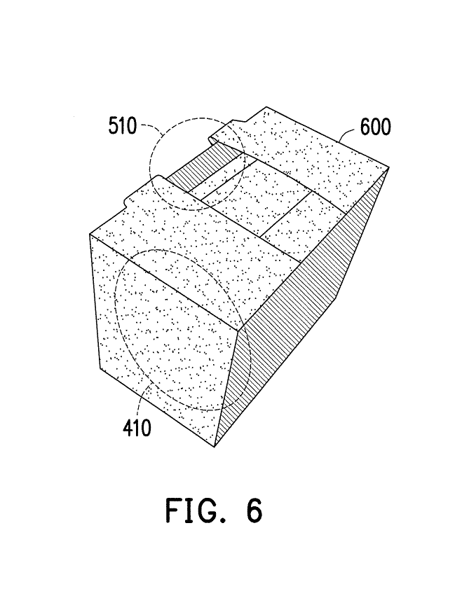

FIG. 3 is a flow chart illustrating an exposure control method according to an embodiment of the invention. FIG. 4 is a schematic view illustrating an overexposed stereo image according to an embodiment of the invention. FIG. 5 is a schematic view illustrating an underexposed stereo image according to an embodiment of the invention. FIG. 6 is a schematic view illustrating a combination of an overexposed stereo image and an underexposed stereo image according to an embodiment of the invention.

Referring to FIG. 3 to FIG. 6, in step S301, the structured lights with the scanning patterns are projected on the object T by the projector 110 with the first projector brightness to scan the object T, and the first images of the object T corresponding to the scanning patterns are captured by the image capturing apparatus 120 to form a first image group.

In step S303, a first stereo image is calculated by the processor 130 according to the first images. As shown in FIG. 4, an object in a first stereo image 400 has an overexposed portion 410, and the lack of image information in the overexposed portion 410 is caused by overexposure.

In step S305, the structured lights with the scanning patterns are projected on the object T by the projector 130 with the second projector brightness to scan the object T, and the second images of the object T corresponding to the scanning patterns are captured by the image capturing apparatus 120 to form a second image group. The second projector brightness is less than the first projector brightness (e.g., the second projector brightness is half the first projector brightness).

In step S307, a second stereo image is calculated by the processor 130 according to the second images. As shown in FIG. 5, an object in a second stereo image 500 has an underexposed portion 510, and the lack of image information in the underexposed portion 510 is caused by low pixel confidence or underexposed pixels. Specifically, if a variation degree of the brightness of a pixel in an image group is overly low, it may be difficult to distinguish a phase signal of the pixel from noise, and thus an error may be easily generated when calculating the stereo image. The pixel is then deleted owing to low confidence and is categorized as the underexposed portion 510. Besides, if a region to which a pixel belongs is too dark, the pixel may also be deleted owing to underexposure and may be categorized as the underexposed portion 510.

In step S309, the first stereo image 400 and the second stereo image 500 are stitched by the processor 130 to obtain a first complete stereo image 600. As shown in FIG. 6, the stereo image information of the overexposed portion 410 in the first complete stereo image 600 may be obtained from a corresponding portion of the second stereo image 500, and the stereo image information of the underexposed portion 510 may be obtained from a corresponding portion of the first stereo image 400. Thereby, the first complete stereo image 600 having both the overexposed portion information and the underexposed portion information is obtained.

It is worth noting that although two stereo images corresponding to two different projector brightnesses are stitched in the embodiment, i.e., the first stereo image 400 and the second stereo image 500 corresponding to the first projector brightness and the second projector brightness are stitched to obtain the complete stereo image, the invention is not limited thereto. In another embodiment, the first stereo image 400, the second stereo image 500, and a third stereo image (not shown) corresponding to the first projector brightness, the second projector brightness, and a third projector brightness may also be stitched to obtain the complete stereo image. Here, the second projector brightness may be less than the first projector brightness, and the third projector brightness may be greater than the first projector brightness. For example, the second projector brightness may be half the first projector brightness, and the third projector brightness may be two times greater than the first projector brightness. If the complete stereo image is obtained by stitching the images with the three different projector brightnesses, the issue of overexposure or underexposure in the stitched complete stereo image may be avoided.

In view of the foregoing, according to the exposure control method and the exposure control apparatus provided herein, the structured lights with the scanning patterns may be projected on an object by the projector with different projector brightnesses to scan the object, the images corresponding to the scanning patterns are captured, and then the stereo images corresponding to the different projector brightnesses are calculated. Finally, the stereo images corresponding to the different projector brightnesses are stitched to obtain the complete stereo image. As such, accuracy of stereo scanning is enhanced, and the issue of overexposure or underexposure in the stereo image may be resolved to a better degree.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A structured-light-based exposure control method suitable for an exposure control apparatus having a projector and an image capturing apparatus, the method comprising:
projecting a plurality of structured lights with a plurality of scanning patterns on an object by the projector with a first projector brightness to scan the object, and capturing a plurality of first images of the object corresponding to the scanning patterns by the image capturing apparatus;
calculating a first stereo image according to the first images;
projecting the structured lights with the scanning patterns on an object by the projector with a second projector brightness to scan the object, and capturing a plurality of second images of the object corresponding to the scanning patterns, wherein the second projector brightness is less than the first projector brightness;
calculating a second stereo image according to the second images; and
stitching the first stereo image and the second stereo image to obtain a first complete stereo image.

2. The structured-light-based exposure control method as claimed in claim further comprising:
projecting the structured lights with the scanning patterns on an object by the projector with a third projector brightness to scan the object, and capturing a plurality of third images of the object corresponding to the scanning patterns, wherein the third projector brightness is greater than the first projector brightness;
calculating a third stereo image according to the third images; and
stitching the first stereo image, the second stereo image, and the third stereo image to obtain a second complete stereo image.

3. The structured-light-based exposure control method as claimed in claim 2, wherein the second projector brightness is half the first projector brightness.

4. The structured-light-based exposure control method as claimed in claim 2, wherein the third projector brightness is two times greater than the first projector brightness.

5. The structured-light-based exposure control method as claimed in claim 1, wherein the scanning patterns comprise specific patterns of a first spatial frequency and a second spatial frequency.

6. The structured-light-based exposure control method as claimed in claim 1, wherein each of the structured lights of the scanning patterns has at least three different phase shifts, and each of the phase shifts respectively corresponds to one of the first images and the second images.

7. A structured-light-based exposure control apparatus, comprising:
a projector;
an image capturing apparatus; and
a processor, coupled to the projector and the image capturing apparatus,
wherein the processor instructs the projector with a first projector brightness to project a plurality of structured lights with a plurality of scanning patterns on an object to scan the object and instructs the image capturing apparatus to capture a plurality of first images of the object corresponding to the scanning patterns,
wherein the processor calculates a first stereo image according to the first images,
wherein the processor instructs the projector with a second projector brightness to project the structured lights with the scanning patterns on the object to scan the object and instructs the image capturing apparatus to capture a plurality of second images of the object corresponding to the scanning patterns, wherein the second projector brightness is less than the first projector brightness,
wherein the processor calculates a second stereo image according to the second images,
wherein the processor stitches the first stereo image and the second stereo image to obtain a first complete stereo image.

8. The structured-light-based exposure control apparatus as claimed in claim 7,
wherein the processor instructs the projector to project the structured lights with the scanning patterns on the object with a third projector brightness to scan the object and instructs the image capturing apparatus to capture a plurality of third images of the object corresponding to the scanning patterns, wherein the third projector brightness is greater than the first projector brightness,
wherein the processor calculates a third stereo image according to the third images,
wherein the processor stitches the first stereo image, the second stereo image, and the third stereo image to obtain a second complete stereo image.

9. The structured-light-based exposure control apparatus as claimed in claim 8, wherein the second projector brightness is half the first projector brightness.

10. The structured-light-based exposure control apparatus as claimed in claim 8, wherein the third projector brightness is two times greater than the first projector brightness.

11. The structured-light-based exposure control apparatus as claimed in claim 7, wherein the scanning patterns comprise specific patterns of a first spatial frequency and a second spatial frequency.

12. The structured-light-based exposure control apparatus as claimed in claim 7, wherein each of the structured lights of the scanning patterns has at least three different phase shifts, and each of the phase shifts respectively corresponds to one of the first images and the second images.
